(19) United States
(12) Patent Application Publication
(10) Pub. No.: US 2009/0014626 A1
(43) Pub. Date: Jan. 15, 2009

(54) STREET LAMP

(75) Inventors: YUAN-FA CHU, Chu-Nan (TW); YING-CHUAN YU, Chu-Nan (TW); WEN-JANG JIANG, Chu-Nan (TW)

Correspondence Address: PCE INDUSTRY, INC.;ATT. CHENG-JU CHIANG, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/135,821

(22) Filed: Jun. 9, 2008

(30) Foreign Application Priority Data
Jul. 12, 2007 (CN) 200710201055.9

(51) Int. Cl. G01J 1/44

(52) U.S. Cl. 250/206

(57) ABSTRACT

A street lamp includes a lamp holder; a light generating unit, a brightness measuring unit and a display unit. The light generating unit is arranged on the lamp holder for emitting light. The brightness measuring unit is arranged on the lamp holder and exposed to light radiation of the light generating unit. The brightness measuring unit is configured for measuring a brightness of the light generating unit. The display unit is arranged on the lamp holder for displaying information associated with the brightness measured by the brightness measuring unit

### BACKGROUND OF THE INVENTION

1. Field of the Invention

The present invention relates generally to a street lamp, and particularly to a street lamp incorporating light emitting diodes as light source.

2. Description of Related Art

In recent years, light emitting diodes (LEDs) are widely used as light source in fields such as automotive, display screens, and street lamps. When the LEDs emit light, heat is produced and thus increases working temperature of the LEDs. A luminous intensity of the LEDs decreases as the working temperature of the LEDs increase, resulting a shorten lifespan of the LEDs. When the LEDs have aged, the LEDs should be replaced. However, the street lamp can not display the aging information of the LEDs, and thus the LEDs can not be replaced timely.

Therefore, a new street lamp is desired to overcome the above described shortcomings.

### SUMMARY OF THE INVENTION

In accordance with the present embodiment, a street lamp includes a lamp holder; a light generating unit, a brightness measuring unit and a display unit. The light generating unit is arranged on the lamp holder for emitting light. The brightness measuring unit is arranged on the lamp holder and exposed to light radiation of the light generating unit. The brightness measuring unit is configured for measuring a brightness of the light generating unit. The display unit is arranged on the lamp holder for displaying information associated with the brightness measured by the brightness measuring unit.

Other advantages and novel features of the present invention will be drawn from the following detailed description of a preferred embodiment of the present invention with attached drawings.

### BRIEF DESCRIPTION OF THE DRAWINGS

The present invention is described in greater detail hereinafter, by way of example only, through description of a preferred embodiment thereof and with reference to the accompanying drawing in which:

FIG. 1 is a schematic view of a street lamp according to a preferred embodiment of the present invention; and

FIG. 2 is a block diagram showing circuits of the street lamp of FIG. 1.

### DETAILED DESCRIPTION OF THE INVENTION

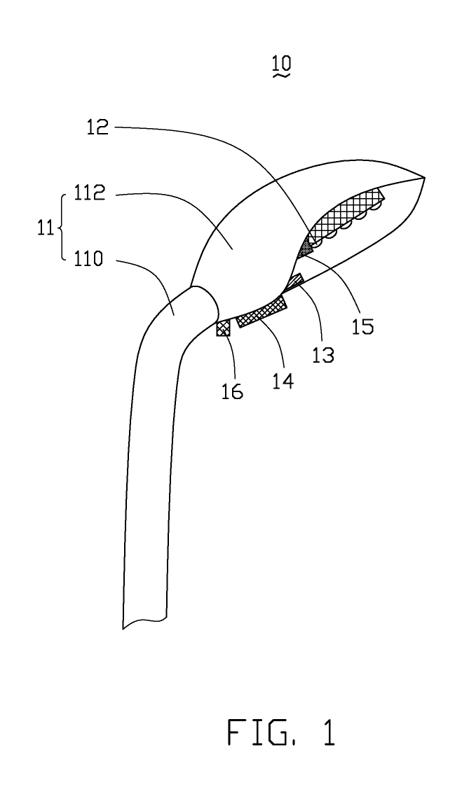

The detailed explanation of a street lamp according to a preferred embodiment of the present invention will now be made with reference to the drawings attached hereto. Referring to FIG. 1, the street lamp 10 includes a lamp holder 11, a brightness measuring unit 13, a temperature measuring unit 15, and a display unit 14.

In the present embodiment, the lamp holder 11 includes a lamppost 110 and a lampshade 112. The lamppost 110 is disposed substantially vertical relative to the ground. A bottom portion of the lamppost 110 is fixedly mounted on the ground. The lampshade 112 is connected to a top portion of the lamppost 110. A plurality of light generating elements 12 are mounted in the lampshade 112. The light generating elements 12 are configured for emitting light. In the present embodiment, the light generating elements 12 are light emitting diodes. Alternatively, light bulb, sodium lamp and so on can be used as a light source of the street lamp 10.

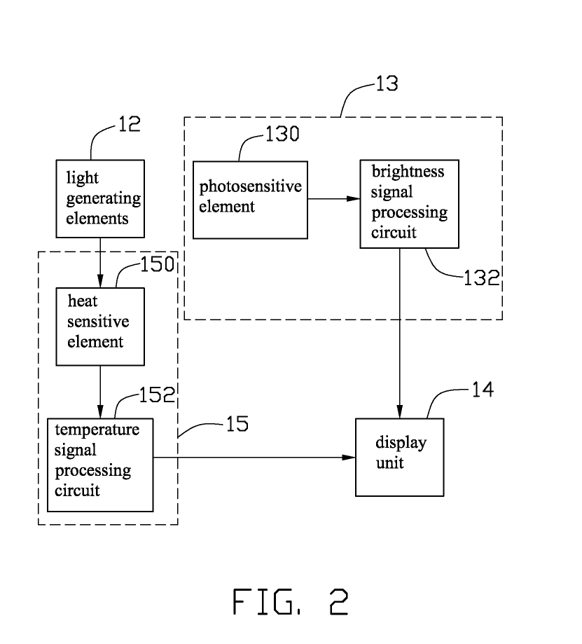

The brightness measuring unit 13 is configured for measuring the brightness of the light emitted from the light generating elements 12 and thus generates a signal according to the brightness of the light generating elements 12 to the display unit 14. The brightness measuring unit 13 is exposed to light radiation of the light generating elements 12. In the present embodiment, the brightness measuring unit 13 is arranged on the lampshade 112. Alternatively, the brightness measuring unit 13 can be arranged on the lamppost 110. Referring to FIG. 2, the brightness measuring unit 13 includes a photosensitive element 130, and a brightness signal processing circuit 132. The photosensitive element 130 is configured for sensing the intensity of the light emitted thereon and thus generates signal representative of the intensity of the light to the brightness signal processing unit 132. The photosensitive element 130 can be a photosensitive resistor, a photosensitive diode or a photosensitive transistor. The brightness signal processing circuit 132 generates displaying signals corresponding to the signal generated by the photosensitive element 130 and transmits the display signals to the display unit 14. In other words, the brightness measuring unit 13 generates different signals to the display unit 14 corresponding to different intensity of the light of the light generating elements 12.

The temperature measuring unit 15 is arranged adjacent to the light generating elements 12 to sense the temperature of the light generating elements 12. The temperature measuring unit 15 includes a heat sensitive element 150 and a temperature signal processing circuit 152. The heat sensitive element 150 is configured for sensing the temperature of the light generating elements 12 and thus outputting signal representative of the temperature of the light generating elements 12 to the temperature signal processing circuit 152, the temperature signal processing circuit 152 configured for generating displaying signals corresponding to the signal generated by the heat sensitive element 150 and transmitting the display signals to the display unit 14. In other words, the temperature measuring unit 15 generates different signals to the display unit 14 corresponding to different temperature of the light generating elements 12.

The display unit 14 is configured for displaying the information about the brightness and the temperature of the light generating elements 12. The display unit 14 can be arranged on the lamppost 110 or on the lampshade 112. The display unit 14 can be a liquid crystal display (LCD) or a light emitting diode (LED) dot matrix display screen. Thus, conditions (temperature and brightness) of the light generating elements 12 of the street lamp 10 can be monitored by the information displayed on the display unit 14. A receiving unit 16 is arranged on the lamp holder 11 to receive information, such as traffic control, traffic accident, air temperature, humidity, advertisement and so on. The receiving unit 16 is connected to the display unit 14 and thus the traffic information, the weather information, and advertisement can be displayed on the display unit 14. The receiving unit 16 can be an infrared receiver, a micro receiver or a bluetooth receiver.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A street lamp, comprising:
a lamp holder;
a light generating unit arranged on the lamp holder for emitting light;
a brightness measuring unit arranged on the lamp holder and exposed to light radiation of the light generating unit, the brightness measuring unit being configured for measuring a brightness of the light generating unit; and
a display unit arranged on the lamp holder for displaying information associated with the brightness measured by the brightness measuring unit.

2. The street lamp of claim 1, wherein the lamp holder comprises a lamppost and a lampshade arranged at a top portion of the lamppost, the light generating unit being received in the lampshade, the display unit and the brightness measuring unit being respectively arranged on the lamppost and the lampshade.

3. The street lamp of claim 1, wherein the brightness measuring unit comprises a photosensitive element and a brightness signal processing circuit, the photosensitive element being configured for sensing the intensity of the light emitted from the light generating unit and outputting a signal representative of the intensity of the light to the brightness signal processing circuit, the signal processing circuit configured for generating displaying signals corresponding to the signal generated by the photosensitive element and transmitting the display signals to the display unit.

4. The street lamp of claim 3, wherein the photosensitive element is one of a photosensitive resistor, a photosensitive diode and a photosensitive transistor.

5. The street lamp of claim 1, further comprising a temperature measuring unit arranged adjacent to the light generating unit to sense the temperature of the light generating unit.

6. The street lamp of claim 5, wherein the temperature measuring unit comprises a heat sensitive element and a temperature signal processing circuit, the heat sensitive element being configured for sensing the temperature of the light generating unit and outputting signal representative of the temperature of the light generating elements to the temperature signal processing circuit, the temperature signal processing circuit configured for generating displaying signals corresponding to the signal generated by the heat sensitive element and transmitting the display signals to the display unit.

7. The street lamp of claim 5, wherein the heat sensitive element is one of a heat sensitive resistor, a heat sensitive diode and a thermocouple.

8. The street lamp of claim 1, wherein the display unit is one of a liquid crystal display and a light emitting diode dot matrix display screen.

9. The street lamp of claim 1, further comprising a receiving unit arranged on the lamp holder to receive information and send the information to the display unit for display.

10. The street lamp of claim 9, wherein the receiving unit is one of an infrared receiver, a micro receiver and a bluetooth receiver.

11. The street lamp of claim 1, wherein the light generating unit comprises a plurality of light emitting diodes.

12. A street lamp, comprising:
a lamp holder comprising a lamppost and a lampshade connected to a top portion of the lamppost;
a light emitting diode array arranged in the lampshade and configured for emitting light;
a brightness measuring unit exposed to light radiating of the light emitting diode array and configured for sensing an intensity of the light; and
a display unit connected to the brightness measuring unit to display an information associated with the brightness of the light emitting diode array according to the intensity of the light emitted therefrom.

13. The street lamp of claim 12, further comprising a temperature measuring unit arranged adjacent to the light emitting diode array to sense the temperature of the light emitting diode array and send a signal representative of the temperature to the display unit for display.
